(19) United States
(12) Patent Application Publication
(10) Pub. No.: US 2009/0146611 A1
(43) Pub. Date: Jun. 11, 2009

(54) Automatic discharging apparatus

(76) Inventor: Rui Hong Weng, Tai Shan Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,816

(22) Filed: Dec. 5, 2007

(51) Int. Cl. H02J 7/00

(52) U.S. Cl. 320/135

(57) ABSTRACT

The present invention discloses an automatic discharging apparatus used for discharging a battery disposed internally therein periodically. The apparatus includes a power source; a load; a battery connected to the power source and the load, wherein the battery supplies power to the load during a power failure; and a controller connected to the battery and the power source for discharging the battery periodically.

### BACKGROUND OF THE INVENTION

1. Field of the Invention

The present invention relates to an automatic discharging apparatus. In particular, the automatic discharging apparatus discharges a battery disposed internally therein periodically.

2. Description of the Related Art

Urgent lights have been handed on important positions of the current building, such as the staircase and the sidewalk etc. Those urgent lights use to light those important positions during a power failure.

Moreover, the urgent light has a battery disposed internally therein, wherein the battery is in discharging status, while user starts the discharging operation or during a power failure. Therefore, the battery of the urgent light is usually in charging status by a power, or provides power for lighting during a power failure.

However, when the battery is usually in charging status that the battery temperature will higher than normal temperature. Besides, after the battery providing power for lighting in short-term and presently is re-charged, the battery will generate the memory effects and the useful life of the battery will decrease.

Therefore, it's important to discharge the battery of the urgent light periodically for extending the useful life of the battery, while the battery of the urgent light is charged during the normal power supply.

### SUMMARY OF THE INVENTION

The present invention provides an automatic discharging apparatus so as to discharge a battery disposed internally therein periodically for extending the useful life of the battery.

The present invention includes a power source; a load; a battery connected to the power source and the load, wherein the battery supplies power to the load during a power failure; and a controller connected to the battery and the power source for discharging the battery periodically.

Moreover, the controller includes an oscillator outputting a clock signal; a counter connected to the oscillator for receiving the clock signal and outputting a enabling signal; an interlock circuit connected to the counter for receiving the enabling signal and outputting a control signal; a driver circuit connected to the interlock circuit for receiving the control signal and outputting a drive signal; and a relay having an exciting coil connected to the drive circuit, and a contact connected to the battery and the power source, moreover, the contact disconnects the battery from the power source and connects the battery from the power source in response to the work of the exciting coil.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the appearance of the automatic discharging apparatus of the present invention;

FIG. 2 is a circuit block schematic diagram of the automatic discharging apparatus of the present invention;

FIG. 3 and FIG. 3A are circuit schematic diagrams of the automatic discharging apparatus of the present invention; and

FIG. 4 is a circuit schematic diagram of the controller of another embodiment of the present invention.

### DETAILED DESCRIPTION OF THE PREFERRED EMBODIMENTS

The automatic discharging apparatus of the present invention is used to discharge a battery disposed internally therein periodically for extending the useful life of the battery, wherein the battery is long-term charge. Therefore, the embodiment of the present invention is the application of an urgent light, and that application isn't the limitation of the present invention.

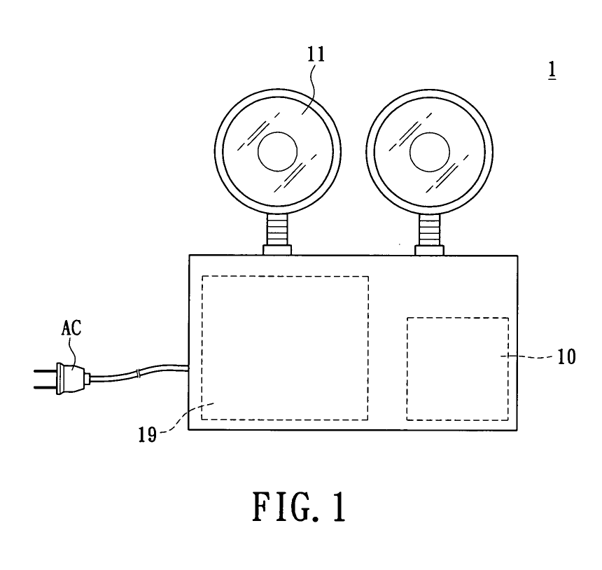

Reference is made to FIG. 1, which shows a schematic diagram of the appearance of the automatic discharging apparatus of the present invention. The automatic discharging apparatus 1 includes a power source AC, a load 11, a battery 19 and a controller 10. Moreover, the battery 19 connects to the power source AC and the load 11, wherein the battery 19 supplies power to the load 11 during a power failure. The controller 10 connects to the battery 19 and the power source AC for discharging the battery 19 periodically.

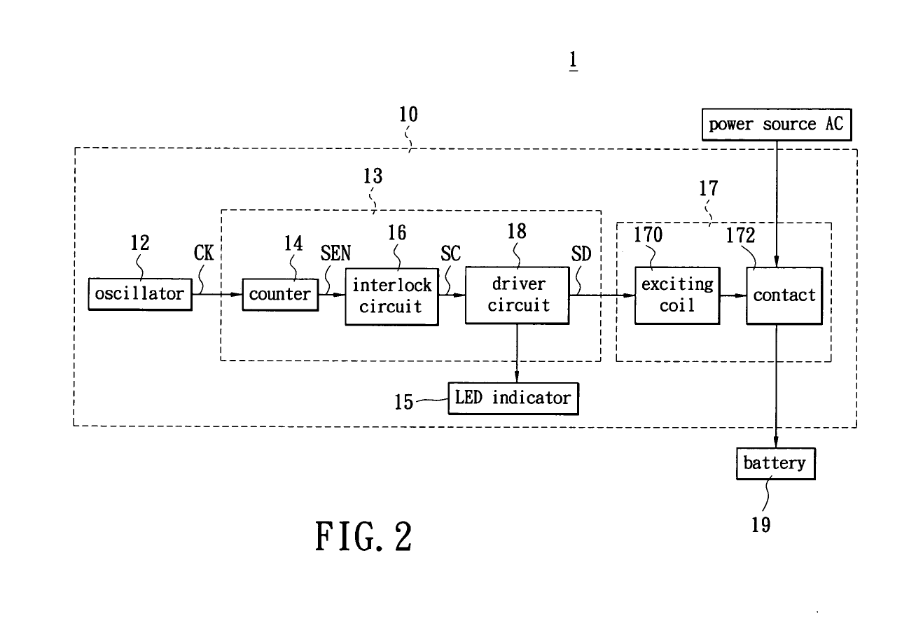

Reference is made to FIG. 2, which shows a circuit block schematic diagram of the automatic discharging apparatus of the present invention. The automatic discharging apparatus 1 utilizes the controller 10 for discharging the battery 19 periodically. The controller 10 includes an oscillator 12, a periodic driving module 13 and a relay 17, wherein the oscillator 12 uses to output a clock signal CK. The periodic driving module 13 connects to the oscillator 12 for receiving the clock signal CK and outputting a driving signal SD periodically. The relay 17 connects to the periodic driving module 13, which is controlled by the driving signal SD for disconnecting the battery 19 from the power source AC and connecting the battery 19 from the power source AC periodically.

Reference is made to FIG. 2 again. The periodic driving module 13 includes a counter 14, an interlock circuit 16 and a driver circuit 18, wherein the counter 14 connects to the oscillator 12 for receiving the clock signal CK and outputting a enabling signal SEN. The interlock circuit 16 connects to the counter 14 for receiving the enabling signal SEN and outputting a control signal SC. The driver circuit 18 connects to the interlock circuit 16 for receiving the control signal SC and outputting the drive signal SD.

Moreover, the relay 17 has an exciting coil 170 and a contact 172, wherein the exciting coil 170 connects to the drive circuit 18, and the contact 172 connects to the battery 19 and the power source AC. Furthermore, the contact 172 disconnects the battery 19 from the power source AC and connects the battery 19 from the power source AC in response to the work of the exciting coil 170. Accordingly, when the exciting coil 170 is excited and the contact 172 is turned off for disconnecting the battery 19 from the power source AC, on the contrary, the contact 172 is turned on for connecting the battery 19 from the power source AC.

Reference is made to FIG. 2 again. The clock signal CK generated from the oscillator 12 is the reference clock of the controller 10. Therefore, the counter 14 of the controller 10 works in response to the clock signal CK, and the enabling signal SEN generated from the controller 10 periodically in response to the time setting of the counter 14. Moreover, the interlock circuit 16 uses to avoid the interference between each enabling signal SEN, and transmits the control signal SC to the driver circuit 18 according to the enabling signal SEN. The driver circuit 18 excites the exciting coil 170 of the relay 17 and turns off the contact 172 so as to disconnect the battery 19 from the power source AC for discharging the battery 19. Furthermore, the driver circuit 18 further connects to a LED indicator 15, wherein the LED indicator 15 uses to indicate that the battery 19 is in charging status or discharging status for users.

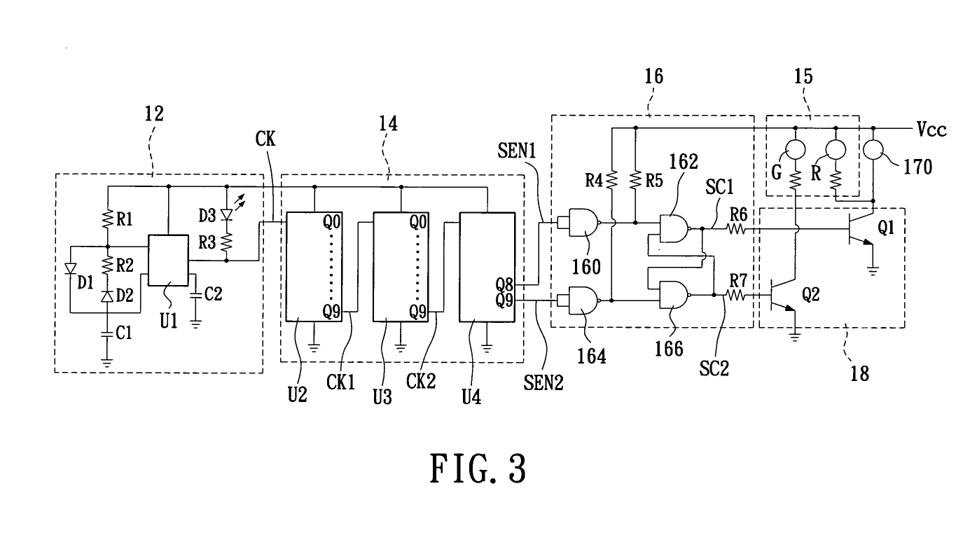

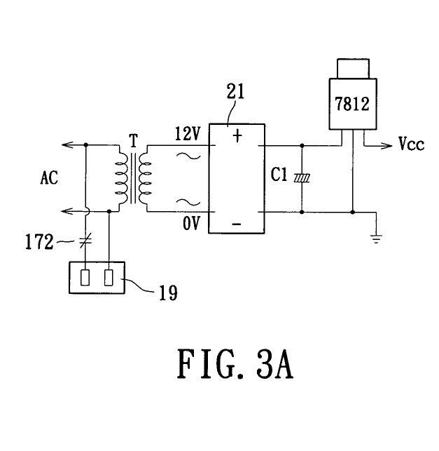

Reference is made to FIG. 3 and FIG. 3A, which show circuit schematic diagrams of the automatic discharging apparatus of the present invention. The oscillator 12 includes a 555 IC U1, at least one resistor R1˜R3, at least one capacitor C1˜C2 and at least one diode D1˜D3. Accordingly, the value of the resistor R1 is ten times greater than the resistor R2 and the period T of the clock signal CK can be shown as formula (I).

T=1.386×R×C (1)

In formula (1), wherein the R is the value of the resistor R1 and the C is the value of the capacitor C1.

Reference is made to FIG. 3 again, the counter 14 includes 4017 ICs U2˜U4, wherein the 4017 IC U2 receives the clock signal CK and counts the period number of the clock signal CK. Then the 4017 IC U2 is in turn to output a clock signal CK1 from its output terminals Q0˜Q9 respectively. Similarly, the 4017 IC U3 receives the clock signal CK 1 and counts the period number of the clock signal CK 1. Then the 4017 IC U3 is in turn to output a clock signal CK2 from its output terminals Q0˜Q9 respectively. Moreover, the 4017 IC U4 receives the clock signal CK 2 and counts the period number of the clock signal CK 2. Then the 4017 IC U4 outputs a first enabling signal SEN1 and a second enabling signal SEN2 from its output terminals Q8˜Q9 respectively.

Furthermore, user can set the discharging time of the battery 19 according to the connection of the 4017 ICs U2˜U4, wherein the discharging time exists between the generated times of the first enabling signal SEN1 and the second enabling signal SEN2. Additionally, the interlock circuit 16 includes a 4011 IC and resistors R4-R7, wherein the 4011 IC packages NAND gates 160˜166.

Reference is made to FIG. 3 again, the interlock circuit 16 receives the first enabling signal SEN1 and transmits the first control signal SC1 to the driver circuit 18 for turning on a first power switch Q1, while the first enabling signal SEN1 is at the high level. At the same time, the exciting coil 170 of the relay 17 is excited and the contact 172 of the relay 17 is turned off. The contact 172 uses to disconnect the battery 19 from the power source AC for discharging the battery 19 according to the conducted first power switch Q1.

Reference is made to FIG. 3 again, the interlock circuit 16 receives the first enabling signal SEN1 and transmits the first control signal SC1 to the driver circuit 18 for turning off the first power switch Q1, and transmits a second control signal SC2 to the driver circuit 18 for turning on the second power switch Q2, while the first enabling signal SEN1 is at the low level. At the same time, the exciting coil 170 of the relay 17 is non-excited and the contact 172 of the relay 17 is turned on. The contact 172 uses to connect the battery 19 from the power source AC for charging the battery 19 according to the non-conducted first power switch Q1.

Reference is made to FIG. 3 again, a red LED R of the LED indicator 15 is lighted for indicating that the battery is in discharging status, while the first power switch Q1 is conducted. Moreover, a green LED G of the LED indicator 15 is lighted for indicating that the battery is in charging status, while the second power switch Q2 is conducted.

Reference is made to FIG. 3A again, a transformer T, a rectifier 21, a filter C1 and a constant voltage regulator 7812 are utilized to generate a work voltage Vcc for each loads of the automatic discharging apparatus 1 according to the power source AC.

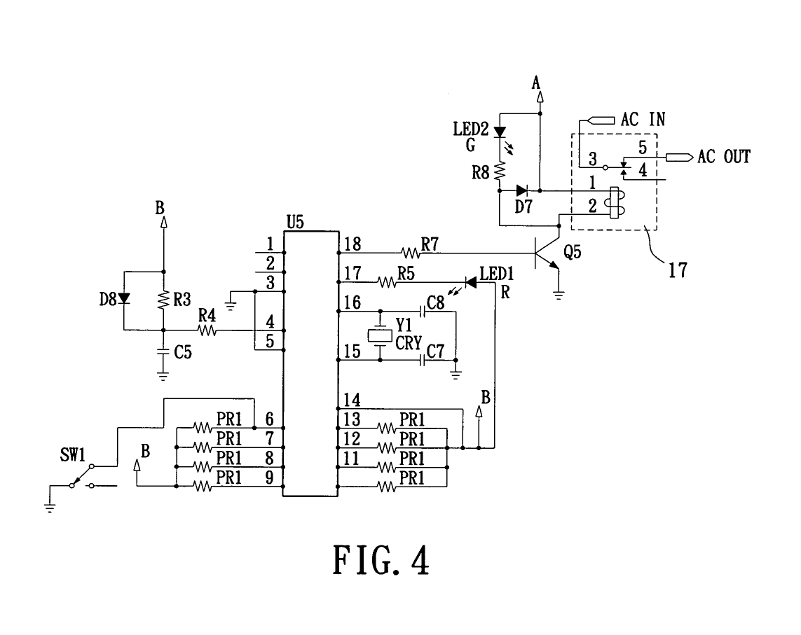

Reference is made to FIG. 4, shows a circuit schematic diagram of the controller of another embodiment of the present invention. The controller 10 includes an oscillator Y1, LED indicators LED1˜LED2, a relay 17 and a periodic driving module 13. Moreover, the periodic driving module 13 includes a counter, an interlock and a driver circuit, wherein the counter, the interlock and the driver circuit are packaged into an IC U5.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An automatic discharging apparatus, comprising:
a power source;
a load;
a battery connected to the power source and the load, wherein the battery supplies power to the load during a power failure; and
a controller connected to the battery and the power source for discharging the battery periodically.

2. The automatic discharging apparatus as claimed in claim 1, wherein the controller comprises:
an oscillator for outputting a clock signal;
a periodic driving module connected to the oscillator for receiving the clock signal and outputting a driving signal periodically; and
a relay connected to the periodic driving module and controlled by the driving signal for disconnecting the battery from the power source and connecting the battery from the power source periodically.

3. The automatic discharging apparatus as claimed in claim 2, wherein the periodic driving module comprises:
a counter connected to the oscillator for receiving the clock signal and outputting a enabling signal;
a n interlock circuit connected to the counter for receiving the enabling signal and outputting a control signal; and
a driver circuit connected to the interlock circuit for receiving the control signal and outputting the drive signal.

4. The automatic discharging apparatus as claimed in claim 3, wherein the relay has an exciting coil connected to the drive circuit, and a contact connected to the battery and the power source, moreover, the contact disconnects the battery from the power source and connects the battery from the power source in response to the work of the exciting coil.

5. The automatic discharging apparatus as claimed in claim 3, wherein the counter, the interlock circuit and the driver circuit are packaged into an IC.

6. The automatic discharging apparatus as claimed in claim 2, wherein the oscillator comprises a 555 IC, at least one resistor, at least one capacitor and at least one diode.

7. The automatic discharging apparatus as claimed in claim 3, wherein the counter comprises at least one 4017 IC.

8. The automatic discharging apparatus as claimed in claim 3, wherein the interlock circuit comprises a 4011 IC and at least one resistor.

9. The automatic discharging apparatus as claimed in claim 2, further comprising a LED indicator connected to the periodic driving module for indicating that the battery is in charging status or discharging status.
